(19) United States
(12) Patent Application Publication
(10) Pub. No.: US 2021/0113872 A1
(43) Pub. Date: Apr. 22, 2021

(54) THROUGH FASTENING UNIT

(71) Applicant: SEUNGJIN IND. CO., LTD., Gyeonggi-do (KR)

(72) Inventor: Woon Taek Jung, Gyeonggi-do (KR)

(73) Assignee: SEUNGJIN IND. CO., LTD., Gyeonggi-do (KR)

(21) Appl. No.: 17/069,249

(22) Filed: Oct. 13, 2020

(30) Foreign Application Priority Data
Oct. 16, 2019 (KR) 10-2019-0128187

(51) Int. Cl. A62C 35/68; F16L 5/10; B05B 15/65; F16L 15/00

(52) U.S. Cl. CPC A62C 35/68; F16L 15/006; B05B 15/65; F16L 5/10

(57) ABSTRACT

Disclosed is a through fastening unit including a pipe-receiving structure located at a ceiling, the pipe-receiving structure being fixed to the ceiling while surrounding a reducer, an attachment and detachment member configured to surround the reducer between the pipe-receiving structure and the reducer, and a tightening pipe configured to cover the attachment and detachment member together with the reducer in the vicinity of the attachment and detachment member and to surround the reducer between the pipe-receiving structure and the attachment and detachment member, the tightening pipe being screw-engaged with the pipe-receiving structure, wherein the tightening pipe moves relative to the pipe-receiving structure in a longitudinal direction of the reducer between the pipe-receiving structure and the attachment and detachment member to bring the attachment and detachment member into tight contact with the reducer or to separate the attachment and detachment member from the reducer.

### CROSS-REFERENCE TO RELATED APPLICATION

This application claims priority from Korean Patent Application No. 10-2019-0128187, filed on Oct. 16, 2019, in the Korean Intellectual Property Office, the disclosure of which is incorporated herein by reference in its entirety.

### BACKGROUND OF THE INVENTION

### 1. Field of the Invention

The present invention relates to a through fastening unit configured to, in fire-fighting equipment of a building, fix a cylindrical reducer, configured to connect a flexible pipe and a sprinkler of the fire-fighting equipment to each other in order to respectively mount the flexible pipe and the sprinkler to the upper side and the lower side of a ceiling of the building, to the ceiling, the reducer extending through the ceiling.

### 2. Description of the Related Art

Generally, in order to connect a flexible pipe and a sprinkler to a cylindrical reducer extending through a ceiling of a building such that the flexible pipe is located at the upper side of the ceiling and the sprinkler is located at the lower side of the ceiling, a center bracket is formed in a “[” shape and is used to fix the reducer to the ceiling while surrounding the reducer at the lower side or the upper side of the ceiling.

For example, in a T-grid ceiling of a building, the center bracket is configured to fix side brackets to opposite sides of a quadrangular grid using first bolts, to connect and fix opposite ends of a quadrangular support bar to the side brackets in the state in which the quadrangular support bar is fitted in one side of the center bracket, and to receive a circular reducer in the other side of the center bracket such that the reducer is fixed to the quadrangular support bar.

Here, the center bracket has a circular insertion hole formed in the other side thereof, and receives the reducer through the insertion hole such that the reducer extends through the center bracket. The reducer and the quadrangular support bar face each other in the center bracket. In addition, the quadrangular support bar extends through the center bracket from the vicinity of the center bracket, and is pushed from the center bracket toward the reducer using second bolts configured to contact the quadrangular support bar, whereby the quadrangular support bar is brought into contact with the reducer.

Subsequently, the reducer is connected to the flexible pipe at the upper side of the ceiling and is connected to the sprinkler at the lower side of the ceiling in the state of protruding from the lowermost surface of the quadrangular grid. Since the center bracket is brought into line contact with the reducer through the circular insertion hole, however, it is not possible for the center bracket to securely fix the reducer to the ceiling while vibration related to a natural disaster of the building or vibration related to discharge of fire-fighting water from the sprinkler occurs.

In addition, the center bracket induces point contact between the quadrangular support bar and the reducer through the quadrangular support bar using the pressurized state of the second bolts. Since the point contact between the quadrangular support bar and the reducer is weaker than the line contact between the quadrangular support bar and the reducer, however, it is not possible to securely prevent movement of the reducer even in the case in which an external shape (i.e. the coupling structure between the quadrangular support bar and the second bolts) is added based on an internal shape (i.e. the structure of the center bracket) when viewed in whole.

In addition, since the center bracket uses a separate structure (i.e. the side brackets and the first bolts) in order to add the external shape based on the internal shape, a complicated shape must be realized on the quadrangular grid of the ceiling with difficulty, and difficult work must be repeatedly performed on the T-grid ceiling. Meanwhile, the center bracket is similarly disclosed in Korean Registered Patent No. 10-1552459 as the prior art.

### SUMMARY OF THE INVENTION

The present invention has been made in view of the above problems, and it is an object of the present invention to provide a through fastening unit suitable to realize a simple shape at a portion of a ceiling and thus to repeatedly perform simple work on the entirety of the ceiling in order to fix a reducer to the ceiling in fire-fighting equipment of a building.

In accordance with the present invention, the above and other objects can be accomplished by the provision of a through fastening unit configured to, in fire-fighting equipment of a building, fix a cylindrical reducer, configured to connect a flexible pipe and a sprinkler of the fire-fighting equipment to each other in order to respectively mount the flexible pipe and the sprinkler to an upper side and a lower side of a ceiling of the building, to the ceiling, the reducer extending through the ceiling, the through fastening unit including a pipe-receiving structure located at the ceiling, the pipe-receiving structure being fixed to the ceiling while surrounding the reducer, an attachment and detachment member configured to surround the reducer between the pipe-receiving structure and the reducer, and a tightening pipe configured to cover the attachment and detachment member together with the reducer in the vicinity of the attachment and detachment member and to surround the reducer between the pipe-receiving structure and the attachment and detachment member, the tightening pipe being screw-engaged with the pipe-receiving structure, wherein the tightening pipe moves relative to the pipe-receiving structure in a longitudinal direction of the reducer between the pipe-receiving structure and the attachment and detachment member to bring the attachment and detachment member into tight contact with the reducer or to separate the attachment and detachment member from the reducer.

The pipe-receiving structure may be located at the upper side of the ceiling while surrounding the reducer or may be located at the upper side and the lower side of the ceiling while surrounding the reducer.

When the pipe-receiving structure is located at the upper side of the ceiling, the pipe-receiving structure may include a receiving pipe and a pipe-fixing bracket at the upper side of the ceiling, and the receiving pipe and the pipe-fixing bracket may be coupled to each other, whereby the receiving pipe may be fixed to the ceiling via the pipe-fixing bracket.

The pipe-fixing bracket may be formed of a flat piece at the ceiling, and the pipe-fixing bracket may have a fixing ring configured to allow the receiving pipe and the reducer to extend therethrough at a central region of the pipe-fixing bracket and coupling recesses formed in opposite edges of the pipe-fixing bracket so as to have a predetermined width by cutting from an end of each edge to the central region of the pipe-fixing bracket such that screw members are inserted into the ceiling therethrough.

The receiving pipe may be configured to have a flange shape on the pipe-fixing bracket, to be inserted into the fixing ring of the pipe-fixing bracket to surround the reducer, and to be screw-engaged with the pipe-fixing bracket through the fixing ring of the pipe-fixing bracket.

When the pipe-receiving structure is located at the upper side and the lower side of the ceiling, the pipe-receiving structure may include a first receiving pipe and a second receiving pipe, and the first receiving pipe and the second receiving pipe may be coupled to each other while having first and second flange shapes at the upper side and the lower side of the ceiling, respectively, whereby the first receiving pipe and the second receiving pipe may be fixed to the ceiling.

The first receiving pipe may be configured to surround the reducer in a thickness direction of the ceiling, to extend through the ceiling in the state of being in tight contact with the reducer along an outer circumferential surface of the reducer in the ceiling or in the state of being in partial contact with the outer circumferential surface of the reducer in the ceiling, to have an end at the same level together with the reducer based on the ceiling at the lower side of the ceiling, to have a first flange shape along a lower edge of the first receiving pipe at the upper side of the ceiling, and to have a first external airtightness retention ring between the ceiling and the first receiving pipe along the outer circumferential surface of the reducer using the first flange shape at the upper side of the ceiling.

The second receiving pipe may be configured to have a first flange shape along an upper edge of the second receiving pipe at the lower side of the ceiling, to have a second external airtightness retention ring between the ceiling and the second receiving pipe along an outer circumferential surface of the first receiving pipe using the second flange shape at the lower side of the ceiling, and to be located along the outer circumferential surface of the first receiving pipe at the lower side of the ceiling so as to be screw-engaged with the first receiving pipe.

When the pipe-receiving structure is located at the upper side and the lower side of the ceiling, the pipe-receiving structure may include a first receiving pipe and a second receiving pipe, and the first receiving pipe and the second receiving pipe may be coupled to the reducer while having first and second flange shapes at the upper side and the lower side of the ceiling, respectively, whereby the first receiving pipe and the second receiving pipe may be fixed to the ceiling.

The first receiving pipe may be configured to surround the reducer at the upper side of the ceiling, to have a first flange shape along the lower edge of the first receiving pipe at the upper side of the ceiling, to have an external airtightness retention ring between the ceiling and the first receiving pipe along the outer circumferential surface of the reducer using the first flange shape at the upper side of the ceiling, and to be fixed to the ceiling in the state of being in contact with the ceiling by inserting a screw member through the first flange shape.

The second receiving pipe may be configured to have a second flange shape along the upper edge of the second receiving pipe at the lower side of the ceiling and to be located along the outer circumferential surface of the reducer at the lower side of the ceiling so as to be screw-engaged with the reducer.

The attachment and detachment member may be configured to have a thickness gradually decreased from the bottom of the receiving pipe toward the tightening pipe, to protrude more than the receiving pipe when viewed based on the pipe-fixing bracket, and to be cut out in an outer circumferential surface of the attachment and detachment member vertically in the longitudinal direction of the reducer by a predetermined width or to have a plurality of recesses configured to open one end of the attachment and detachment member in the longitudinal direction of the reducer in the outer circumferential surface of the attachment and detachment member.

When the attachment and detachment member is cut out vertically in the longitudinal direction of the reducer by the predetermined width, the attachment and detachment member may be configured to be located on the pipe-fixing bracket between the receiving pipe, the tightening pipe, and the reducer and to move in the longitudinal direction of the reducer through movement of the tightening pipe relative to the receiving pipe such that the attachment and detachment member gradually enters the tightening pipe in the state of being in contact with the bottom of the receiving pipe while reducing the cut-out width or to move in the longitudinal direction of the reducer through movement of the tightening pipe relative to the receiving pipe such that the attachment and detachment member gradually retreats from the interior of the tightening pipe in the state of being in contact with the bottom of the receiving pipe while restoring the cut-out width.

When the attachment and detachment member has the plurality of recesses in the outer circumferential surface of the attachment and detachment member the attachment and detachment member may be configured to be located on the pipe-fixing bracket between the receiving pipe, the tightening pipe, and the reducer and to move in the longitudinal direction of the reducer through movement of the tightening pipe relative to the receiving pipe such that the attachment and detachment member gradually enters the tightening pipe in the state of being in contact with the bottom of the receiving pipe while reducing the width of each recess or to move in the longitudinal direction of the reducer through movement of the tightening pipe relative to the receiving pipe such that the attachment and detachment member gradually retreats from the interior of the tightening pipe in the state of being in contact with the bottom of the receiving pipe while restoring the width of each recess.

The attachment and detachment member may be configured to have a thickness gradually decreased from the first receiving pipe toward the tightening pipe, to protrude more than the first receiving pipe when viewed based on the ceiling, and to be cut out in the outer circumferential surface of the attachment and detachment member vertically in the longitudinal direction of the reducer by a predetermined width or to have a plurality of recesses configured to open one end of the attachment and detachment member in the longitudinal direction of the reducer in the outer circumferential surface of the attachment and detachment member.

When the attachment and detachment member is cut out vertically in the longitudinal direction of the reducer by the predetermined width, the attachment and detachment member may be configured to be located on the ceiling between the receiving pipe, the tightening pipe, and the reducer and to move in the longitudinal direction of the reducer through movement of the tightening pipe relative to the first receiving pipe such that the attachment and detachment member gradually enters the tightening pipe when viewed from the bottom of the first receiving pipe while reducing the cut-out width or to move in the longitudinal direction of the reducer through movement of the tightening pipe relative to the first receiving pipe such that the attachment and detachment member gradually retreats from the interior of the tightening pipe when viewed from the bottom of the first receiving pipe while restoring the cut-out width.

When the attachment and detachment member has the plurality of recesses in the outer circumferential surface of the attachment and detachment member, the attachment and detachment member may be configured to be located on the ceiling between the first receiving pipe, the tightening pipe, and the reducer and to move in the longitudinal direction of the reducer through movement of the tightening pipe relative to the first receiving pipe such that the attachment and detachment member gradually enters the tightening pipe when viewed from the bottom of the first receiving pipe while reducing the width of each recess or to move in the longitudinal direction of the reducer through movement of the tightening pipe relative to the receiving pipe such that the attachment and detachment member gradually retreats from the interior of the tightening pipe when viewed from the bottom of the first receiving pipe while restoring the width of each recess.

The tightening pipe may be configured to be located in the receiving pipe on the attachment and detachment member so as to face the receiving pipe in parallel and to be screw-engaged with the receiving pipe, such that the thickness of the tightening pipe is increased and decreased in a shape reverse to the shape of the attachment and detachment member, whereby the attachment and detachment member and the tightening pipe face each other in an inclined state on the reducer, when the tightening pipe gradually enters the receiving pipe, to enable the attachment and detachment member to gradually enter the tightening pipe in the state in which the attachment and detachment member is pressurized, whereby the tightening pipe brings the attachment and detachment member into tight contact with the bottom of the receiving pipe and the outer circumferential surface of the reducer, and when the tightening pipe gradually retreats from an interior of the receiving pipe, to enable the attachment and detachment member to gradually retreat from the interior of the tightening pipe in the state in which the attachment and detachment member is released, whereby the tightening pipe brings the attachment and detachment member into tight contact with the bottom of the receiving pipe and separates the attachment and detachment member from the outer circumferential surface of the reducer, and the attachment and detachment member may be cut out in the outer circumferential surface thereof vertically in the longitudinal direction of the reducer by a predetermined width or may have a plurality of recesses in the outer circumferential surface thereof.

The through fastening unit may further include an internal airtightness retention ring and a ring compression washer sequentially stacked on the bottom of the first receiving pipe between the first receiving pipe and the attachment and detachment member, wherein the tightening pipe may be configured to be located in the first receiving pipe on the attachment and detachment member so as to face the first receiving pipe in parallel and to be screw-engaged with the first receiving pipe, such that the thickness of the tightening pipe is increased and decreased in a shape reverse to the shape of the attachment and detachment member, whereby the attachment and detachment member and the tightening pipe face each other in an inclined state on the reducer, when the tightening pipe gradually enters the first receiving pipe, to enable the attachment and detachment member to gradually enter the tightening pipe in the state in which the attachment and detachment member is pressurized, whereby the tightening pipe brings the attachment and detachment member into tight contact with an outer circumferential surface of the reducer together with the ring compression washer, and when the tightening pipe gradually retreats from the interior of the first receiving pipe, to enable the attachment and detachment member to gradually retreat from the interior of the tightening pipe in the state in which the attachment and detachment member is released, whereby the tightening pipe brings the attachment and detachment member into tight contact with the ring compression washer and separates the attachment and detachment member from the outer circumferential surface of the reducer, and the attachment and detachment member may be cut out in the outer circumferential surface thereof vertically in the longitudinal direction of the reducer by a predetermined width or may have a plurality of recesses in the outer circumferential surface thereof.

The through fastening unit may further include an external airtightness retention ring configured to surround the reducer along the outer circumferential surface of the reducer in the ceiling, wherein the external airtightness retention ring may be located between the receiving pipe and the sprinkler.

The through fastening unit may further include a protective net under the second receiving pipe at the lower side of the ceiling, wherein the protective net may be located along a lower edge of the second receiving pipe while surrounding the sprinkler so as to be screw-engaged with the lower edge of the second receiving pipe.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A and 1B are sectional views showing a through fastening unit according to a first embodiment of the present invention;

FIG. 2 is a plan view showing a pipe-fixing bracket in the through fastening unit of FIG. 1;

FIG. 3 is a multilateral view (i.e. a side view and a plan view) showing the coupling relationship between the pipe-fixing bracket, a pipe-receiving structure, and a tightening pipe in the through fastening unit of FIG. 1;

FIG. 4 is an image showing an attachment and detachment member in the through fastening unit of FIG. 1;

FIGS. 5A, 5B and 5C are sectional views showing a through fastening unit according to a second embodiment of the present invention;

FIGS. 6A, 6B and 6C are sectional views showing a through fastening unit according to a third embodiment of the present invention;

FIG. 7 is a sectional view showing a through fastening unit according to a fourth embodiment of the present invention;

FIG. 8 is a schematic view showing a modification of the attachment and detachment member of FIG. 4; and

FIG. 9 is a schematic view illustrating a method of using the through fastening unit of FIG. 1.

FIGS. 10A, 10B and 10C are schematic views illustrating a method of using the through fastening unit of FIG. 1.

### DETAILED DESCRIPTION OF THE PREFERRED EMBODIMENTS

Hereinafter, preferred embodiments of the present invention will be described in detail with reference to the accompanying drawings such that the present invention can be easily embodied by a person having ordinary skill in the art to which the present invention pertains.

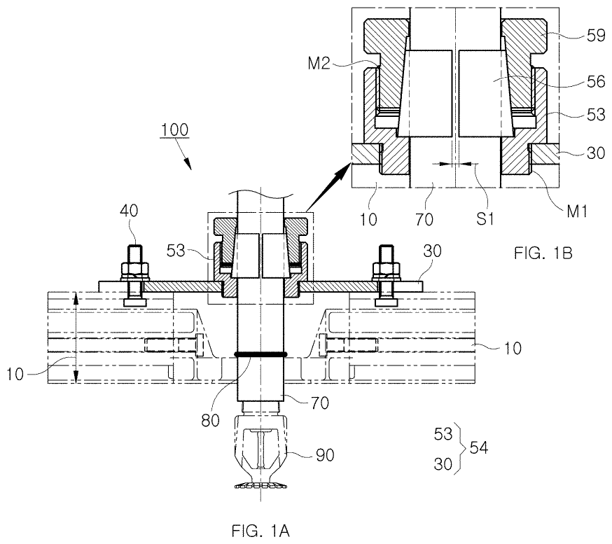

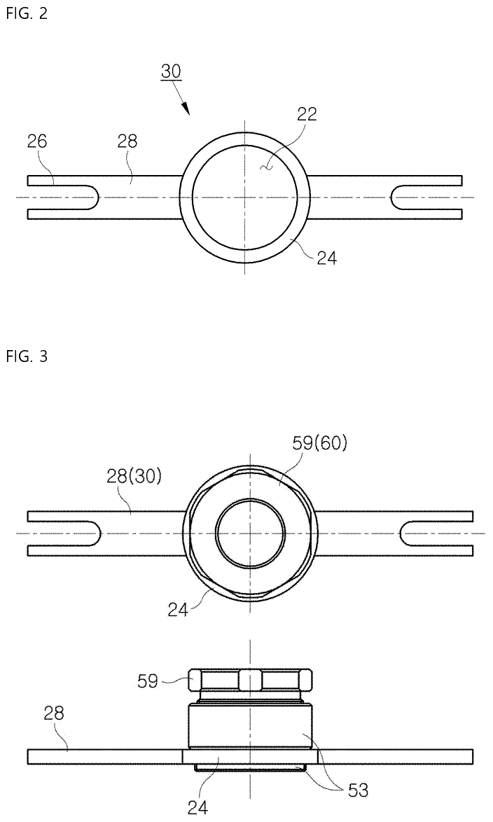

FIGS. 1A and 1B (collectively referred to herein as FIG. 1) are sectional views showing a through fastening unit according to a first embodiment of the present invention, and FIG. 2 is a plan view showing a pipe-fixing bracket in the through fastening unit of FIG. 1.

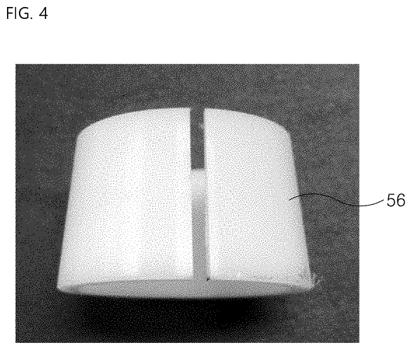

In addition, FIG. 3 is a multilateral view (i.e. a side view and a plan view) showing the coupling relationship between the pipe-fixing bracket, a pipe-receiving structure, and a tightening pipe in the through fastening unit of FIG. 1, and FIG. 4 is an image showing an attachment and detachment member in the through fastening unit of FIG. 1.

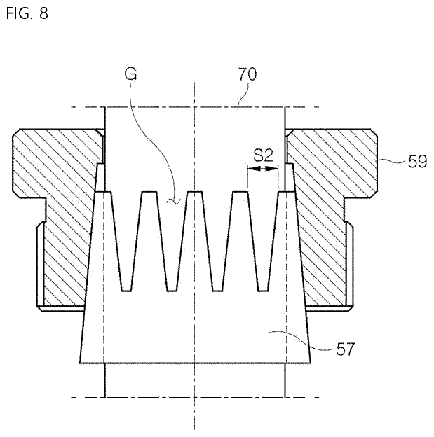

In addition, FIG. 8 is a schematic view showing a modification of the attachment and detachment member of FIG. 4.

Referring to FIGS. 1 to 4 and 8, the through fastening unit 100 is configured to, in fire-fighting equipment of a building (not shown), fix a cylindrical reducer 70, configured to connect a flexible pipe (not shown) and a sprinkler of the fire-fighting equipment to each other in order to respectively mount the flexible pipe and the sprinkler to the upper side and the lower side of a ceiling 10 of the building, to the ceiling 10, the reducer extending through the ceiling 10.

To this end, the through fastening unit 100 includes a pipe-receiving structure 54, an attachment and detachment member 56, and a tightening pipe 59. Each of the pipe-receiving structure 54 and the tightening pipe 59 is made of a metallic material, and the attachment and detachment member 56 is made of an elastic material including plastic. The pipe-receiving structure 54 is located at the ceiling 10 and is fixed to the ceiling while surrounding the reducer 70.

Here, the pipe-receiving structure 54 is located at the upper side of the ceiling 10 while surrounding the reducer 70. When the pipe-receiving structure 54 is located at the upper side of the ceiling 10, the pipe-receiving structure 54 includes a pipe-fixing bracket 30 and a receiving pipe 53 at the upper side of the ceiling 10. The pipe-fixing bracket 30 and the receiving pipe 53 are coupled to each other, whereby the receiving pipe 53 is fixed to the ceiling 10 via the pipe-fixing bracket 30.

The pipe-fixing bracket 30 is formed of a flat piece at the ceiling 10, and has a fixing ring 24 configured to allow the receiving pipe 53 and the reducer 70 to extend therethrough at a central region of the pipe-fixing bracket 30 and coupling recesses 26 formed in opposite edges of the pipe-fixing bracket 30 so as to have a predetermined width by cutting from the end of each edge to the central region of the pipe-fixing bracket 30 such that screw members 40 are inserted into the ceiling 10 therethrough.

The receiving pipe 53 has a flange shape on the pipe-fixing bracket 30, is inserted into a fixing hole 22 in the fixing ring 24 of the pipe-fixing bracket 30 to surround the reducer 70, and is screw-engaged (M1) with the pipe-fixing bracket 30 through the fixing ring 24 of the pipe-fixing bracket 30. The attachment and detachment member 56 surrounds the reducer 70 between the pipe-receiving structure 54 and the reducer 70.

More specifically, the attachment and detachment member 56 has a thickness gradually decreased from the bottom of the receiving pipe 53 toward the tightening pipe 59, protrudes more than the receiving pipe 53 when viewed based on the pipe-fixing bracket 30, and is cut out in the outer circumferential surface of the attachment and detachment member 56 vertically in a longitudinal direction of the reducer 70 by a predetermined width S1. When the attachment and detachment member 56 is cut out vertically in the longitudinal direction of the reducer 70 by the predetermined width S1, the attachment and detachment member 56 is located on the pipe-fixing bracket 30 between the receiving pipe 53, the tightening pipe 59, and the reducer 70.

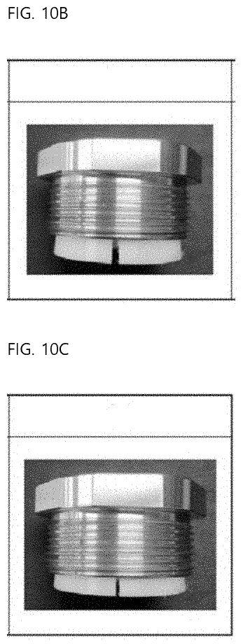

Here, the attachment and detachment member 56 moves in the longitudinal direction of the reducer 70 through the movement of the tightening pipe 59 relative to the receiving pipe 53 such that the attachment and detachment member 56 gradually enters the tightening pipe 59 in the state of being in contact with the bottom of the receiving pipe 53 while reducing the cut-out width S1, as shown in FIGS. 10A, 10B and 10C, or moves in the longitudinal direction of the reducer 70 through the movement of the tightening pipe 59 relative to the receiving pipe 53 such that the attachment and detachment member 56 gradually retreats from the interior of the tightening pipe 59 in the state of being in contact with the bottom of the receiving pipe 53 while restoring the cut-out width S1, as shown in FIGS. 10A, 10B and 10C.

Alternatively, the attachment and detachment member may be replaced with an attachment and detachment member 57 of FIG. 8. The attachment and detachment member 57 has a thickness gradually decreased from the bottom of the receiving pipe 53 toward the tightening pipe 59, protrudes more than the receiving pipe 53 when viewed based on the pipe-fixing bracket 30, and has a plurality of recesses G configured to open one end of the attachment and detachment member 57 in the longitudinal direction of the reducer 70 in the outer circumferential surface of the attachment and detachment member 57.

When the attachment and detachment member 57 has the plurality of recesses G in the outer circumferential surface of the attachment and detachment member 57, the attachment and detachment member 57 is located on the pipe-fixing bracket 30 between the receiving pipe 53, the tightening pipe 59, and the reducer 70, and moves in the longitudinal direction of the reducer 70 through the movement of the tightening pipe 59 relative to the receiving pipe 53 such that the attachment and detachment member 57 gradually enters the tightening pipe 59 in the state of being in contact with the bottom of the receiving pipe 53 while reducing the width S2 of each recess G, or moves in the longitudinal direction of the reducer 70 through the movement of the tightening pipe 59 relative to the receiving pipe 53 such that the attachment and detachment member 57 gradually retreats from the interior of the tightening pipe 59 in the state of being in contact with the bottom of the receiving pipe 53 while restoring the width S2 of each recess G.

Referring back to FIGS. 1 to 4, the tightening pipe 59 covers the attachment and detachment member 56 together with the reducer 70 in the vicinity of the attachment and detachment member 56, surrounds the reducer 70 between the pipe-receiving structure 54 and the attachment and detachment member 56, and is screw-engaged (M2) with the pipe-receiving structure 54. The tightening pipe 59 moves relative to the pipe-receiving structure 54 in the longitudinal direction of the reducer 70 between the pipe-receiving structure 54 and the attachment and detachment member 56 to bring the attachment and detachment member 56 into tight contact with the reducer 70 or to separate the attachment and detachment member 56 from the reducer 70.

More specifically, the tightening pipe 59 is located in the receiving pipe 53 on the attachment and detachment member 56 so as to face the receiving pipe 53 in parallel and to be screw-engaged (M2) with the receiving pipe 53. In addition, the thickness of the tightening pipe 59 is increased and decreased in a shape reverse to the shape of the attachment and detachment member 56 such that the attachment and detachment member 56 and the tightening pipe 59 face each other in an inclined state on the reducer 70.

In addition, when the tightening pipe 59 gradually enters the receiving pipe 53, the tightening pipe 59 enables the attachment and detachment member 56 to gradually enter the tightening pipe 59 in the state in which the attachment and detachment member 56 is pressurized, whereby the tightening pipe 59 brings the attachment and detachment member 56 into tight contact with the bottom of the receiving pipe 53 and the outer circumferential surface of the reducer 70.

In addition, when the tightening pipe 59 gradually retreats from the interior of the receiving pipe 53, the tightening pipe 59 enables the attachment and detachment member 56 to gradually retreat from the interior of the tightening pipe 59 in the state in which the attachment and detachment member 56 is released, whereby the tightening pipe 59 brings the attachment and detachment member 56 into tight contact with the bottom of the receiving pipe 53 and separates the attachment and detachment member 56 from the outer circumferential surface of the reducer 70. Here, the attachment and detachment member 56 may be replaced with the attachment and detachment member 57 of FIG. 8.

Consequently, the attachment and detachment member 56 or 57 is cut out in the outer circumferential surface thereof vertically in the longitudinal direction of the reducer 70 by the predetermined width S1, or has the plurality of recesses G in the outer circumferential surface thereof. Meanwhile, the through fastening unit 100 further includes an external airtightness retention ring 80 configured to surround the reducer 70 along the outer circumferential surface of the reducer 70 in the ceiling 10. The external airtightness retention ring 80 is located between the receiving pipe 53 and a sprinkler 90. The external airtightness retention ring 80 prevents communication between the upper side and the lower side of the ceiling 10.

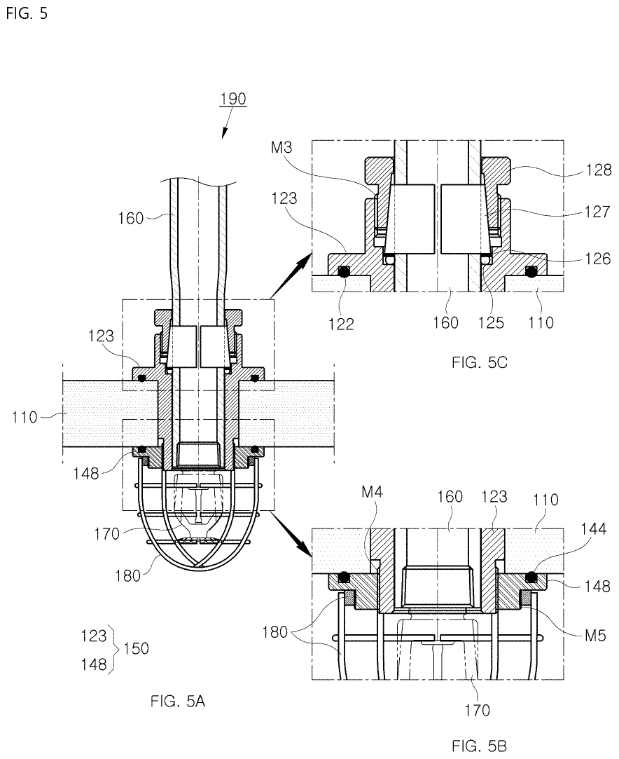

FIGS. 5A, 5B and 5C (collectively referred to herein as FIG. 5) are sectional views showing a through fastening unit according to a second embodiment of the present invention.

Referring to FIG. 5, the through fastening unit 190 is similar to the through fastening unit 100 of FIG. 1 but has a structure different from the structure of the through fastening unit 100 when viewed in detail. Here, the through fastening unit 190 also includes a pipe-receiving structure 150, an attachment and detachment member 127, and a tightening pipe 128. The pipe-receiving structure 150 is located at the upper side and the lower side of a ceiling 110 while surrounding a reducer 160.

More specifically, when the pipe-receiving structure 150 is located at the upper side and the lower side of the ceiling 110, the pipe-receiving structure 150 includes a first receiving pipe 123 and a second receiving pipe 148. The first receiving pipe 123 and the second receiving pipe 148 are coupled to each other while having first and second flange shapes at the upper side and the lower side of the ceiling 110, respectively, whereby the first receiving pipe 123 and the second receiving pipe 148 are fixed to the ceiling 110.

The first receiving pipe 123 surrounds the reducer 160 in a thickness direction of the ceiling 110, extends through the ceiling 110 in the state of being in tight contact with the reducer 160 along the outer circumferential surface of the reducer 160 in the ceiling 110, and has an end at the same level together with the reducer 160 based on the ceiling 110 at the lower side of the ceiling 110.

In addition, the first receiving pipe 123 is formed so as to have a first flange shape along the lower edge of the first receiving pipe 123 at the upper side of the ceiling 110, and has a first external airtightness retention ring 122 between the ceiling 110 and the first receiving pipe 123 along the outer circumferential surface of the reducer 160 using the first flange shape at the upper side of the ceiling 110.

The second receiving pipe 148 is formed so as to have a first flange shape along the upper edge of the second receiving pipe 148 at the lower side of the ceiling 110, has a second external airtightness retention ring 144 between the ceiling 110 and the second receiving pipe 148 along the outer circumferential surface of the first receiving pipe 123 using the second flange shape at the lower side of the ceiling 110, and is located along the outer circumferential surface of the first receiving pipe 123 at the lower side of the ceiling 110 so as to be screw-engaged (M4) with the first receiving pipe 123.

The attachment and detachment member 127 has the same shape as the attachment and detachment member 56 of FIG. 1 or 4. The attachment and detachment member 127 has a thickness gradually decreased from the first receiving pipe 123 toward the tightening pipe 128, protrudes more than the first receiving pipe 123 when viewed based on the ceiling 110, and is cut out in the outer circumferential surface of the attachment and detachment member 127 vertically in a longitudinal direction of the reducer 160 by a predetermined width S1 (see FIG. 1).

When the attachment and detachment member 127 is cut out vertically in the longitudinal direction of the reducer 160 by the predetermined width S1, the attachment and detachment member 127 is located on the ceiling 110 between the first receiving pipe 123, the tightening pipe 128, and the reducer 160, and moves in the longitudinal direction of the reducer 160 through the movement of the tightening pipe 128 relative to the first receiving pipe 123 such that the attachment and detachment member 127 gradually enters the tightening pipe 128 when viewed from the bottom of the first receiving pipe 123 while reducing the cut-out width S1, or moves in the longitudinal direction of the reducer 160 through the movement of the tightening pipe 128 relative to the first receiving pipe 123 such that the attachment and detachment member 127 gradually retreats from the interior of the tightening pipe 128 when viewed from the bottom of the first receiving pipe 123 while restoring the cut-out width S1.

Alternatively, the attachment and detachment member 127 may be replaced with an attachment and detachment member 57 of FIG. 8. The attachment and detachment member 57 has a thickness gradually decreased from the bottom of the first receiving pipe 123 toward the tightening pipe 128, protrudes more than the first receiving pipe 123 when viewed based on the ceiling 110, and has a plurality of recesses G configured to open one end of the attachment and detachment member 57 in the longitudinal direction of the reducer 160 in the outer circumferential surface of the attachment and detachment member 57.

When the attachment and detachment member 57 has the plurality of recesses G in the outer circumferential surface of the attachment and detachment member 57, the attachment and detachment member 57 is located on the ceiling 110 between the first receiving pipe 123, the tightening pipe 128, and the reducer 160, and moves in the longitudinal direction of the reducer 160 through the movement of the tightening pipe 128 relative to the first receiving pipe 123 such that the attachment and detachment member 57 gradually enters the tightening pipe 128 when viewed from the bottom of the first receiving pipe 123 while reducing the width S2 of each recess G, or moves in the longitudinal direction of the reducer 160 through the movement of the tightening pipe 128 relative to the first receiving pipe 123 such that the attachment and detachment member 57 gradually retreats from the interior of the tightening pipe 128 when viewed from the bottom of the first receiving pipe 123 while restoring the width S2 of each recess G.

Referring back to FIG. 5, the through fastening unit 190 further includes an internal airtightness retention ring 125 and a ring compression washer 126 sequentially stacked on the bottom of the first receiving pipe 123 between the first receiving pipe 123 and the attachment and detachment member 127. Here, the tightening pipe 128 is located in the first receiving pipe 123 on the attachment and detachment member 127 so as to face the first receiving pipe 123 in parallel, and is screw-engaged (M3) with the first receiving pipe 123.

In addition, the thickness of the tightening pipe 128 is increased and decreased in a shape reverse to the shape of the attachment and detachment member 127 such that the attachment and detachment member 127 and the tightening pipe 128 face each other in an inclined state on the reducer 160. When the tightening pipe 128 gradually enters the first receiving pipe 123, the tightening pipe 59 enables the attachment and detachment member 127 to gradually enter the tightening pipe 128 in the state in which the attachment and detachment member 127 is pressurized, whereby the tightening pipe 128 brings the attachment and detachment member 127 into tight contact with the outer circumferential surface of the reducer 160 together with the ring compression washer 126.

In addition, when the tightening pipe 128 gradually retreats from the interior of the first receiving pipe 123, the tightening pipe 59 enables the attachment and detachment member 127 to gradually retreat from the interior of the tightening pipe 128 in the state in which the attachment and detachment member 123 is released, whereby the tightening pipe 128 brings the attachment and detachment member 127 into tight contact with the ring compression washer 126 and separates the attachment and detachment member 127 from the outer circumferential surface of the reducer 160.

Here, the attachment and detachment member 127 may be replaced with the attachment and detachment member 57 of FIG. 8. Consequently, the attachment and detachment member 127 or 57 is cut out in the outer circumferential surface thereof vertically in the longitudinal direction of the reducer 160 by the predetermined width S1, or has the plurality of recesses G in the outer circumferential surface thereof. Meanwhile, the through fastening unit 190 further includes a protective net 180 under the second receiving pipe 148 at the lower side of the ceiling 110. The protective net 180 is located along the lower edge of the second receiving pipe 148 while surrounding a sprinkler 170 so as to be screw-engaged (M5) with the lower edge of the second receiving pipe 148.

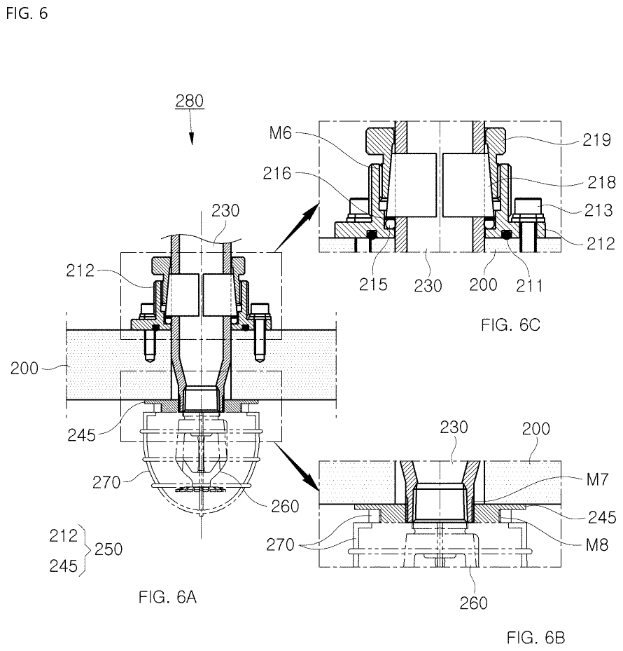

FIGS. 6A, 6B and 6C (collectively referred to herein as FIG. 6) are sectional views showing a through fastening unit according to a third embodiment of the present invention.

Referring to FIG. 6, the through fastening unit 280 is similar to the through fastening unit 190 of FIG. 5 but has a structure different from the structure of the through fastening unit 190 when viewed in detail. Here, the through fastening unit 280 also includes a pipe-receiving structure 250, an attachment and detachment member 218, a tightening pipe 219, and a protective net 270. The pipe-receiving structure 250 is located at the upper side and the lower side of a ceiling 200 while surrounding a reducer 230.

When the pipe-receiving structure 250 is located at the upper side and the lower side of the ceiling 200, the pipe-receiving structure 250 includes a first receiving pipe 212 and a second receiving pipe 245. The first receiving pipe 212 and the second receiving pipe 245 are coupled to the reducer 230 while having first and second flange shapes at the upper side and the lower side of the ceiling 200, whereby the first receiving pipe 212 and the second receiving pipe 245 are fixed to the ceiling 200.

The first receiving pipe 212 surrounds the reducer 230 at the upper side of the ceiling 200, is formed so as to have a first flange shape along the lower edge of the first receiving pipe 212 at the upper side of the ceiling 200, has an external airtightness retention ring 211 between the ceiling 200 and the first receiving pipe 212 along the outer circumferential surface of the reducer 230 using the first flange shape at the upper side of the ceiling 200, and is fixed to the ceiling 200 in the state of being in contact with the ceiling 200 by inserting a screw member 213 through the first flange shape.

The second receiving pipe 245 is formed so as to have a second flange shape along the upper edge of the second receiving pipe 245 at the lower side of the ceiling 200, and is located along the outer circumferential surface of the reducer 230 at the lower side of the ceiling 200 so as to be screw-engaged (M7) with the reducer 230. Meanwhile, the coupling relationship between the first receiving pipe 212, the second receiving pipe 245, the attachment and detachment member 218, the tightening pipe 219, and the protective net 270 is identical to the coupling relationship between the first receiving pipe 123, the second receiving pipe 148, the attachment and detachment member 127, the tightening pipe 128, and the protective net 180 of FIG. 5.

The first receiving pipe 212 and the tightening pipe 219 are screw-engaged (M6) with each other in the first receiving pipe 212. The second receiving pipe 245 and the protective net 270 are screw-engaged (M8) with each other at the lower edge of the second receiving pipe 245. The shape of the attachment and detachment member 218 was described in detail with reference to FIG. 1, 4, or 8.

Meanwhile, the through fastening unit 280 also further includes an internal airtightness retention ring 215 and a ring compression washer 216 between the attachment and detachment member 218 and the first receiving pipe 212, in the same manner as the through fastening unit 190 of FIG. 5. The fastening pipe 219 pressurizes the attachment and detachment member 218 to compress the internal airtightness retention ring 215 on the bottom of the first receiving pipe 212 via the ring compression washer 216.

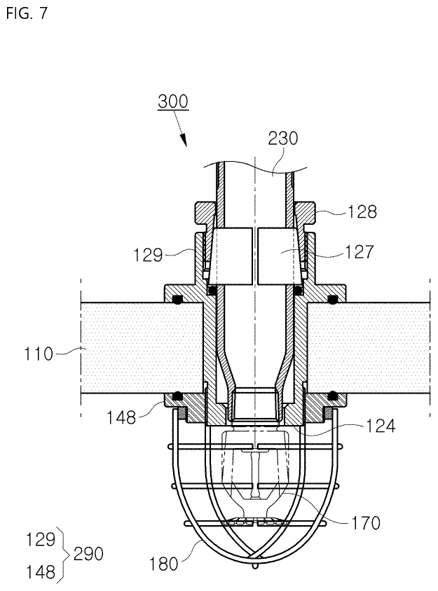

FIG. 7 is a sectional view showing a through fastening unit according to a fourth embodiment of the present invention.

Referring to FIG. 7, the through fastening unit 300 has a structure very similar to the structure of the through fastening unit 190 of FIG. 5, but a first receiving pipe 129 of the through fastening unit 300 is slightly different from the first receiving pipe 123 of the through fastening unit 190 when viewed in part. More specifically, the first receiving pipe 129 surrounds the reducer 230 in the thickness direction of the ceiling 110, and extends through the ceiling 110 in the state of being in partial contact with the outer circumferential surface of the reducer 230 in the ceiling 110.

In addition, the first receiving pipe 129 has an end at the same level together with the reducer 230 based on the ceiling 110 at the lower side of the ceiling 110, is formed so as to have a first flange shape along the lower edge of the first receiving pipe 129 at the upper side of the ceiling 110, and has a first external airtightness retention ring 122 (see FIG. 5) between the ceiling 110 and the first receiving pipe 129 along the outer circumferential surface of the reducer 230 using the first flange shape at the upper side of the ceiling 110.

Here, the first receiving pipe 129 has a protruding edge 124 around the second receiving pipe 148 at the lower side of the ceiling 110, and the protruding edge 124 surrounds an end of the reducer 230. The first receiving pipe 129 and the second receiving pipe 148 constitute a pipe-receiving structure 290.

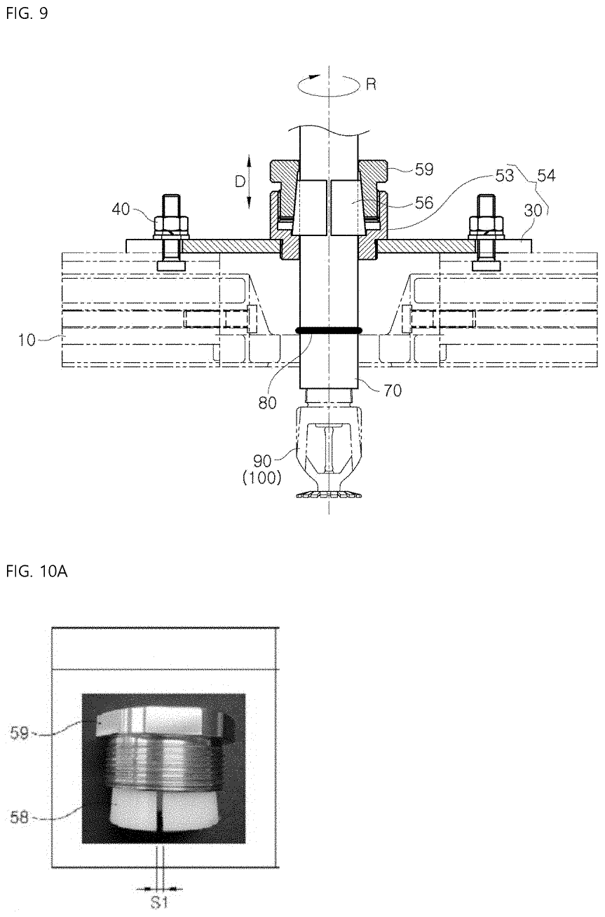

Referring to FIGS. 9, 10A, 10B and 10C, a pipe-fixing bracket 30, a receiving pipe 53, an attachment and detachment member 56, a tightening pipe 59, a reducer 70, and a sprinkler 90 may be prepared. First, the reducer 70 may be located in a ceiling 10 through a concave portion of the ceiling 10. The reducer 70 may be formed in a cylindrical shape, and may have an external airtightness retention ring 80 on the outer circumferential surface thereof.

The concave portion of the ceiling 10 may be filled with a filler (not shown). The filler may surround the reducer 70 in the concave portion of the ceiling 10. Here, the external airtightness retention ring 80 blocks communication between the upper side and the lower side of the ceiling. A fixing ring 24 of the pipe-fixing bracket 30 may be fitted onto the reducer 70. In addition, the pipe-fixing bracket 30 may be fixed to the ceiling 10 using a screw member 40.

Subsequently, the attachment and detachment member 56 may be inserted into the receiving pipe 53 for assembly of the receiving pipe 53, the attachment and detachment member 56, and the tightening pipe 59. The tightening pipe 59 may be located between the receiving pipe 53 and the attachment and detachment member 56, and may be screw-engaged (M2) (see FIG. 1) with the receiving pipe 53. That is, the receiving pipe 53, the attachment and detachment member 56, and the tightening pipe 59 may be prepared as one set in the state in which the attachment and detachment member 56 and the tightening pipe 59 are provided in the receiving pipe 53.

Subsequently, the receiving pipe 53 may be fitted onto the reducer 70, may be inserted into the fixing ring 24 (see FIG. 2) of the pipe-fixing bracket 30, and may be screw-engaged (M1) (see FIG. 1) with the pipe-fixing bracket 30. Here, the receiving pipe 53 may be seated around the fixing ring 24 of the pipe-fixing bracket 30 using a flange shape thereof. As a result, the attachment and detachment member 56 and the tightening pipe 59 may be located on the pipe-fixing bracket 30 while being provided in the receiving pipe 53.

Alternatively, in the state in which the pipe-fixing bracket 30 is fixed to the ceiling 10, the reducer 70 may be inserted into the fixing ring 24 of the pipe-fixing bracket and may then extend through the ceiling 10. Subsequently, the receiving pipe 53, the attachment and detachment member 56, and the tightening pipe 59 may be sequentially fitted onto the reducer 70, and may then be coupled to each other at the fixing ring 24 or on the fixing ring 24 of the pipe-fixing bracket 30.

The receiving pipe 53 and the pipe-fixing bracket 30 may constitute a pipe-receiving structure 54. Subsequently, the tightening pipe 59 may be gradually inserted into the receiving pipe 53. The tightening pipe 59 may be rotated (R) relative to the receiving pipe 53, and thus may move upwards and downwards in one direction D.

At this time, the tightening pipe 59 may move downwards in one direction D to pressurize the attachment and detachment member 56, whereby the attachment and detachment member 56 may be brought into tight contact with the bottom of the receiving pipe 53. More specifically, the attachment and detachment member 56 may move in the longitudinal direction of the reducer 70 through downward movement of the tightening pipe 59 relative to the receiving pipe 53 in one direction D, whereby the attachment and detachment member 56 may gradually enter the tightening pipe 59 in the state of being in contact with the bottom of the receiving pipe 53 while reducing a cut-out width S1, as shown in FIGS. 10A to 10C.

As a result, the attachment and detachment member 56 may maintain airtightness between the receiving pipe 53 and the reducer 70. Alternatively, the attachment and detachment member 56 may move in the longitudinal direction of the reducer 70 through upward movement of the tightening pipe 59 relative to the receiving pipe 53 in one direction D, whereby the attachment and detachment member may gradually retreat from the interior of the tightening pipe 59 in the state of being in contact with the bottom of the receiving pipe 53 while restoring the cut-out width S1, as shown in FIGS. 10C to 10A.

Subsequently, the sprinkler 90 and a flexible pipe (not shown) may be coupled to the reducer 70 at the lower side and the upper side of the ceiling 10, respectively. Meanwhile, the pipe-fixing bracket 30, the receiving pipe 53, the attachment and detachment member 56, the tightening pipe 59, and the external airtightness retention ring 80 may constitute a single through fastening unit 100.

As is apparent from the above description, a through fastening unit according to the present invention includes a receiving pipe, an attachment and detachment member, and a tightening pipe at the upper side of a ceiling as one set, wherein the attachment and detachment member is seated in the receiving pipe, the tightening pipe is located between the receiving pipe and the attachment and detachment member, and a reducer is installed so as to extend through the ceiling via the tightening pipe, the attachment and detachment member, and the receiving pipe in the state in which the receiving pipe and the tightening pipe are screw-engaged with each other, whereby the receiving pipe is fixed only to the upper side of the ceiling or the shape of the receiving pipe is divided such that the receiving pipe is fixed to the upper side and the lower side of the ceiling along the reducer. As a result, it is possible to realize a simple shape at a portion of the ceiling and thus to repeatedly perform simple work on the entirety of the ceiling.

Although the present invention has been described in detail based on concrete embodiments, those skilled in the art will appreciate that the present invention is not limited thereto and that various modifications, additions, and substitutions are possible without departing from the scope and spirit of the invention as disclosed in the accompanying claims.

What is claimed is:

1. A through fastening unit configured to, in fire-fighting equipment of a building, fix a cylindrical reducer, configured to connect a flexible pipe and a sprinkler of the fire-fighting equipment to each other in order to respectively mount the flexible pipe and the sprinkler to an upper side and a lower side of a ceiling of the building, to the ceiling, the reducer extending through the ceiling, the through fastening unit comprising:
a pipe-receiving structure located at the ceiling, the pipe-receiving structure being fixed to the ceiling while surrounding the reducer;
an attachment and detachment member configured to surround the reducer between the pipe-receiving structure and the reducer; and
a tightening pipe configured to cover the attachment and detachment member together with the reducer in a vicinity of the attachment and detachment member and to surround the reducer between the pipe-receiving structure and the attachment and detachment member, the tightening pipe being screw-engaged with the pipe-receiving structure, wherein
the tightening pipe moves relative to the pipe-receiving structure in a longitudinal direction of the reducer between the pipe-receiving structure and the attachment and detachment member to bring the attachment and detachment member into tight contact with the reducer or to separate the attachment and detachment member from the reducer.

2. The through fastening unit according to claim 1, wherein,
when the pipe-receiving structure is located at the upper side of the ceiling while surrounding the reducer, the pipe-receiving structure comprises a receiving pipe and a pipe-fixing bracket at the upper side of the ceiling, or
when the pipe-receiving structure is located at the upper side and the lower side of the ceiling while surrounding the reducer, the pipe-receiving structure comprises a first receiving pipe and a second receiving pipe.

3. The through fastening unit according to claim 2, wherein
when the pipe-receiving structure is located at the upper side of the ceiling,
the receiving pipe and the pipe-fixing bracket are coupled to each other, whereby the receiving pipe is fixed to the ceiling via the pipe-fixing bracket.

4. The through fastening unit according to claim 3, wherein
the pipe-fixing bracket is formed of a flat piece at the ceiling, and
the pipe-fixing bracket has:
a fixing ring configured to allow the receiving pipe and the reducer to extend therethrough at a central region of the pipe-fixing bracket; and
coupling recesses formed in opposite edges of the pipe-fixing bracket so as to have a predetermined width by cutting from an end of each edge to the central region of the pipe-fixing bracket such that screw members are inserted into the ceiling therethrough.

5. The through fastening unit according to claim 4, wherein the receiving pipe is configured:
to have a flange shape on the pipe-fixing bracket;
to be inserted into the fixing ring of the pipe-fixing bracket to surround the reducer; and
to be screw-engaged with the pipe-fixing bracket through the fixing ring of the pipe-fixing bracket.

6. The through fastening unit according to claim 2, wherein
when the pipe-receiving structure is located at the upper side and the lower side of the ceiling,
the first receiving pipe and the second receiving pipe are coupled to each other while having first and second flange shapes at the upper side and the lower side of the ceiling, respectively, whereby the first receiving pipe and the second receiving pipe are fixed to the ceiling.

7. The through fastening unit according to claim 6, wherein the first receiving pipe is configured:
to surround the reducer in a thickness direction of the ceiling;
to extend through the ceiling in a state of being in tight contact with the reducer along an outer circumferential surface of the reducer in the ceiling or in a state of being in partial contact with the outer circumferential surface of the reducer in the ceiling;
to have an end at an identical level together with the reducer based on the ceiling at the lower side of the ceiling;
to have a first flange shape along a lower edge of the first receiving pipe at the upper side of the ceiling; and
to have a first external airtightness retention ring between the ceiling and the first receiving pipe along the outer circumferential surface of the reducer using the first flange shape at the upper side of the ceiling.

8. The through fastening unit according to claim 6, wherein the second receiving pipe is configured:
to have a first flange shape along an upper edge of the second receiving pipe at the lower side of the ceiling;
to have a second external airtightness retention ring between the ceiling and the second receiving pipe along an outer circumferential surface of the first receiving pipe using the second flange shape at the lower side of the ceiling; and
to be located along the outer circumferential surface of the first receiving pipe at the lower side of the ceiling so as to be screw-engaged with the first receiving pipe.

9. The through fastening unit according to claim 2, wherein
when the pipe-receiving structure is located at the upper side and the lower side of the ceiling,
the first receiving pipe and the second receiving pipe are coupled to the reducer while having first and second flange shapes at the upper side and the lower side of the ceiling, respectively, whereby the first receiving pipe and the second receiving pipe are fixed to the ceiling.

10. The through fastening unit according to claim 9, wherein the first receiving pipe is configured:
to surround the reducer at the upper side of the ceiling;
to have a first flange shape along a lower edge of the first receiving pipe at the upper side of the ceiling;
to have an external airtightness retention ring between the ceiling and the first receiving pipe along an outer circumferential surface of the reducer using the first flange shape at the upper side of the ceiling; and
to be fixed to the ceiling in a state of being in contact with the ceiling by inserting a screw member through the first flange shape.

11. The through fastening unit according to claim 9, wherein the second receiving pipe is configured:
to have a second flange shape along an upper edge of the second receiving pipe at the lower side of the ceiling; and
to be located along the outer circumferential surface of the reducer at the lower side of the ceiling so as to be screw-engaged with the reducer.

12. The through fastening unit according to claim 3, wherein the attachment and detachment member is configured:
to have a thickness gradually decreased from a bottom of the receiving pipe toward the tightening pipe;
to protrude more than the receiving pipe when viewed based on the pipe-fixing bracket; and
to be cut out in an outer circumferential surface of the attachment and detachment member vertically in the longitudinal direction of the reducer by a predetermined width or to have a plurality of recesses configured to open one end of the attachment and detachment member in the longitudinal direction of the reducer in the outer circumferential surface of the attachment and detachment member.

13. The through fastening unit according to claim 12, wherein
when the attachment and detachment member is cut out vertically in the longitudinal direction of the reducer by the predetermined width,
the attachment and detachment member is configured:
to be located on the pipe-fixing bracket between the receiving pipe, the tightening pipe, and the reducer; and
to move in the longitudinal direction of the reducer through movement of the tightening pipe relative to the receiving pipe such that the attachment and detachment member gradually enters the tightening pipe in a state of being in contact with the bottom of the receiving pipe while reducing the cut-out width; or
to move in the longitudinal direction of the reducer through movement of the tightening pipe relative to the receiving pipe such that the attachment and detachment member gradually retreats from an interior of the tightening pipe in a state of being in contact with the bottom of the receiving pipe while restoring the cut-out width.

14. The through fastening unit according to claim 12, wherein
when the attachment and detachment member has the plurality of recesses in the outer circumferential surface of the attachment and detachment member,
the attachment and detachment member is configured:
to be located on the pipe-fixing bracket between the receiving pipe, the tightening pipe, and the reducer; and
to move in the longitudinal direction of the reducer through movement of the tightening pipe relative to the receiving pipe such that the attachment and detachment member gradually enters the tightening pipe in a state of being in contact with the bottom of the receiving pipe while reducing a width of each recess; or
to move in the longitudinal direction of the reducer through movement of the tightening pipe relative to the receiving pipe such that the attachment and detachment member gradually retreats from an interior of the tightening pipe in a state of being in contact with the bottom of the receiving pipe while restoring the width of each recess.

15. The through fastening unit according to claim 2, wherein,
when the pipe-receiving structure is located at the upper side and the lower side of the ceiling,
the attachment and detachment member is configured:
to have a thickness gradually decreased from the first receiving pipe toward the tightening pipe;
to protrude more than the first receiving pipe when viewed based on the ceiling; and
to be cut out in an outer circumferential surface of the attachment and detachment member vertically in the longitudinal direction of the reducer by a predetermined width or to have a plurality of recesses configured to open one end of the attachment and detachment member in the longitudinal direction of the reducer in the outer circumferential surface of the attachment and detachment member.

16. The through fastening unit according to claim 15, wherein
when the attachment and detachment member is cut out vertically in the longitudinal direction of the reducer by the predetermined width,
the attachment and detachment member is configured:
to be located on the ceiling between the receiving pipe, the tightening pipe, and the reducer; and
to move in the longitudinal direction of the reducer through movement of the tightening pipe relative to the first receiving pipe such that the attachment and detachment member gradually enters the tightening pipe when viewed from a bottom of the first receiving pipe while reducing the cut-out width; or
to move in the longitudinal direction of the reducer through movement of the tightening pipe relative to the first receiving pipe such that the attachment and detachment member gradually retreats from an interior of the tightening pipe when viewed from the bottom of the first receiving pipe while restoring the cut-out width.

17. The through fastening unit according to claim 15, wherein
when the attachment and detachment member has the plurality of recesses in the outer circumferential surface of the attachment and detachment member,
the attachment and detachment member is configured:
to be located on the ceiling between the first receiving pipe, the tightening pipe, and the reducer; and
to move in the longitudinal direction of the reducer through movement of the tightening pipe relative to the first receiving pipe such that the attachment and detachment member gradually enters the tightening pipe when viewed from a bottom of the first receiving pipe while reducing a width of each recess; or
to move in the longitudinal direction of the reducer through movement of the tightening pipe relative to the receiving pipe such that the attachment and detachment member gradually retreats from an interior of the tightening pipe when viewed from the bottom of the first receiving pipe while restoring the width of each recess.

18. The through fastening unit according to claim 3, wherein the tightening pipe is configured:
to be located in the receiving pipe on the attachment and detachment member so as to face the receiving pipe in parallel and to be screw-engaged with the receiving pipe;
such that a thickness of the tightening pipe is increased and decreased in a shape reverse to a shape of the attachment and detachment member, whereby the attachment and detachment member and the tightening pipe face each other in an inclined state on the reducer;
when the tightening pipe gradually enters the receiving pipe, to enable the attachment and detachment member to gradually enter the tightening pipe in a state in which the attachment and detachment member is pressurized, whereby the tightening pipe brings the attachment and detachment member into tight contact with a bottom of the receiving pipe and an outer circumferential surface of the reducer; and
when the tightening pipe gradually retreats from an interior of the receiving pipe, to enable the attachment and detachment member to gradually retreat from an interior of the tightening pipe in a state in which the attachment and detachment member is released, whereby the tightening pipe brings the attachment and detachment member into tight contact with the bottom of the receiving pipe and separates the attachment and detachment member from the outer circumferential surface of the reducer, and
the attachment and detachment member is cut out in an outer circumferential surface thereof vertically in the longitudinal direction of the reducer by a predetermined width or has a plurality of recesses in the outer circumferential surface thereof.

19. The through fastening unit according to claim 2, when the pipe-receiving structure is located at the upper side and the lower side of the ceiling,
further comprising:
an internal airtightness retention ring and a ring compression washer sequentially stacked on a bottom of the first receiving pipe between the first receiving pipe and the attachment and detachment member, wherein
the tightening pipe is configured:
to be located in the first receiving pipe on the attachment and detachment member so as to face the first receiving pipe in parallel and to be screw-engaged with the first receiving pipe;
such that a thickness of the tightening pipe is increased and decreased in a shape reverse to a shape of the attachment and detachment member, whereby the attachment and detachment member and the tightening pipe face each other in an inclined state on the reducer;
when the tightening pipe gradually enters the first receiving pipe, to enable the attachment and detachment member to gradually enter the tightening pipe in a state in which the attachment and detachment member is pressurized, whereby the tightening pipe brings the attachment and detachment member into tight contact with an outer circumferential surface of the reducer together with the ring compression washer; and
when the tightening pipe gradually retreats from an interior of the first receiving pipe, to enable the attachment and detachment member to gradually retreat from an interior of the tightening pipe in a state in which the attachment and detachment member is released, whereby the tightening pipe brings the attachment and detachment member into tight contact with the ring compression washer and separates the attachment and detachment member from the outer circumferential surface of the reducer, and
the attachment and detachment member is cut out in an outer circumferential surface thereof vertically in the longitudinal direction of the reducer by a predetermined width or has a plurality of recesses in the outer circumferential surface thereof.

20. The through fastening unit according to claim 3, further comprising:
an external airtightness retention ring configured to surround the reducer along an outer circumferential surface of the reducer in the ceiling, wherein
the external airtightness retention ring is located between the receiving pipe and the sprinkler.

21. The through fastening unit according to claim 2, when the pipe-receiving structure is located at the upper side and the lower side of the ceiling,
further comprising:
a protective net under the second receiving pipe at the lower side of the ceiling, wherein
the protective net is located along a lower edge of the second receiving pipe while surrounding the sprinkler so as to be screw-engaged with the lower edge of the second receiving pipe.
